(19) United States
(12) Patent Application Publication
(10) Pub. No.: US 2017/0051818 A1
(43) Pub. Date: Feb. 23, 2017

(54) Device for the Transmission of a Torque with Torsional Vibration Damping

(71) Applicant: ROLLAX GmbH & Co. KG, Bad Salzuflen (DE)

(72) Inventor: Andreas EBKE, Minden (DE)

(21) Appl. No.: 15/308,507

(22) PCT Filed: Apr. 16, 2015
(86) PCT No.: PCT/EP2015/058335

§ 371 Date: Nov. 2, 2016

(30) Foreign Application Priority Data
May 16, 2014 (DE) 20 2014 102 314.3
Nov. 14, 2014 (DE) 20 2014 105 486.3

(51) Int. Cl. F16H 55/36; F16F 15/121; F16D 41/06; F16F 15/123

(52) U.S. Cl. CPC F16H 55/36; F16F 15/123; F16F 15/1215; F16D 41/06; F16H 2055/366

(57) ABSTRACT

A device for transmission of a torque with torsional vibration damping, includes a sprag clutch (14) and a damping element (16) which is arranged coaxially to the sprag clutch (14) and is in driving engagement therewith, wherein the damping element has at least one damping body (38) in the form of a three-dimensional wire meshwork, which is arranged between a torque transmission ring (10) and the sprag clutch (14) and is supported on the torque transmission ring (10) and the sprag clutch (14) in a circumferential direction.

The invention relates to a device for the transmission of a torque with torsional vibration damping, which device has a sprag clutch and a damping element which is arranged coaxially to said sprag clutch and is in driving engagement therewith.

Devices of this type are used for example in vehicles for driving auxiliary equipment such as a dynamo, an air conditioning compressor and the like. By means of the sprag clutch the torque in one rotational sense is transferred from a drive member, e.g. a pulley, via the damping element to a driven element such as a shaft of a dynamo. The damping element serves for damping torsional vibrations and shocks that may be excited by fluctuations in the rotary movement of the drive member and by special operating conditions of the engine and which may easily result in an increased wear of the sprag clutch.

DE 10 2009 014 203 A1 discloses a device of this type wherein the damping element is arranged to surround the sprag clutch in an annular configuration and is formed by an energy storage device in the form of a crest of helical compression springs or optionally in the form of a torsion-elastic damper ring made of an elastomeric material.

It is an object of the invention to improve the damping properties of such a device and to eliminate resonance effects as far as possible.

According to the invention, this object is achieved by the feature that the damping element has at least one damping body in the form of a three-dimensional wire meshwork, which is arranged between a torque transmission ring and the sprag clutch and is supported on the torque transmission ring and the sprag clutch in the circumferential direction.

The damping body may be manufactured in the form of a knitted or crocheted fabric of metal wire which has at least approximately the desired shape and is then transformed into the final shape by means of form pressing, for example. In that case, form-pressing also offers a simple possibility to adjust the density of the meshwork and consequently the deformation stiffness and the progressivity of the spring characteristic as desired. This damping body is superior in its high durability and especially a high chemical resistance and temperature resistance and has excellent damping properties due to the high internal friction. Vibrations can then be attenuated already with a relatively small deformation of the damping body, which avoids material fatigue due to alternating strains and thereby permits to achieve a high life period with very low setting effects.

Since the damping body is arranged between two annular components and is supported in circumferential direction, it is possible to achieve a compact arrangement and a direct torque transfer, wherein the damping effect is achieved by slight elastic—and therefore reversible—compression of the damping body in the circumferential direction. Although the deformation and relaxation of the damping body is elastic, it dissipates a high amount of energy due to friction between the individual meshes of the meshwork, whereby torsional vibrations are damped effectively.

Useful further developments and embodiments of the invention are indicated in the dependent claims.

In one embodiment, the damping element is arranged with form-fit in circumferential direction between ribs which project radially from the torque transmission ring on the one hand and the sprag clutch on the other hand.

The torque may optionally be transferred from the torque transmission ring via the damping element to the sprag clutch or vice versa.

In an advantageous embodiment, the damping element is formed by one or more damping bodies which are disposed in an annular configuration around an outer race of the sprag clutch. For example, four separate damping bodies may be provided each of which extends approximately over a quarter of the periphery of the sprag clutch, and the damping bodies may be supported by an alternating sequence of inwardly projecting ribs of the torque transmission ring and outwardly projecting ribs of the sprag clutch.

Alternatively, the damping elements may be fixedly connected to the inner peripheral surface of the torque transmission ring and the outer peripheral surface of the outer race of the sprag clutch, e.g. by welding, without using projecting rib structures.

In another optional embodiment the damping element is constituted by a one-piece annular damping body which has radial grooves at its inner and outer periphery for receiving the ribs of the toque transmission ring and the sprag clutch. The damping body may in this case also be used for damping radial vibrations.

In yet another embodiment, especially for torque transmission rings that are constituted by pulleys with very small effective diameter, the radial arrangement of the damping body may also be offset axially outwardly into a region beyond the pulley profile.

It is also possible to combine the damping body which is made of wire meshwork with elastic damping elements such as helical springs, dish-springs and/or leaf springs or rubber blocks. For example, the meshwork and the elastic damping elements may be arranged in series so that, for example when the force flows from the torque transmission ring to the sprag clutch, the force is at first transferred from the torque transmission ring to the elastic damping elements and then to the sprag clutch via the meshwork or, conversely, the force of the torque transmission ring acting in circumferential direction is at first transferred to the meshwork and then via the elastic damping elements to the sprag clutch. In these cases, the elastic damping elements permit a larger spring deflection whereas the meshwork achieves a more effective vibration damping.

In another embodiment, the meshwork and the elastic damping elements may be arranged in parallel so that parallel force transmission paths are formed. In this case the elastic damping elements will relieve the meshwork from pressure to some extent.

Embodiment examples will now be described in conjunction with the drawings, wherein:

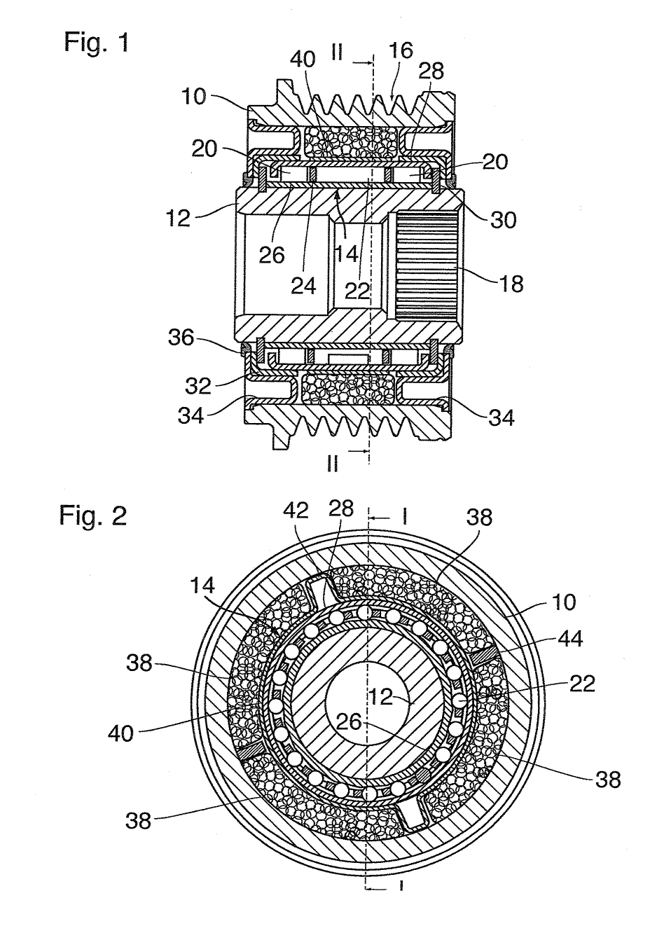

FIG. 1 is an axial sectional view of a torque transmission device according to the invention;

FIG. 2 is a cross-sectional view taken in the plane II-II in FIG. 1;

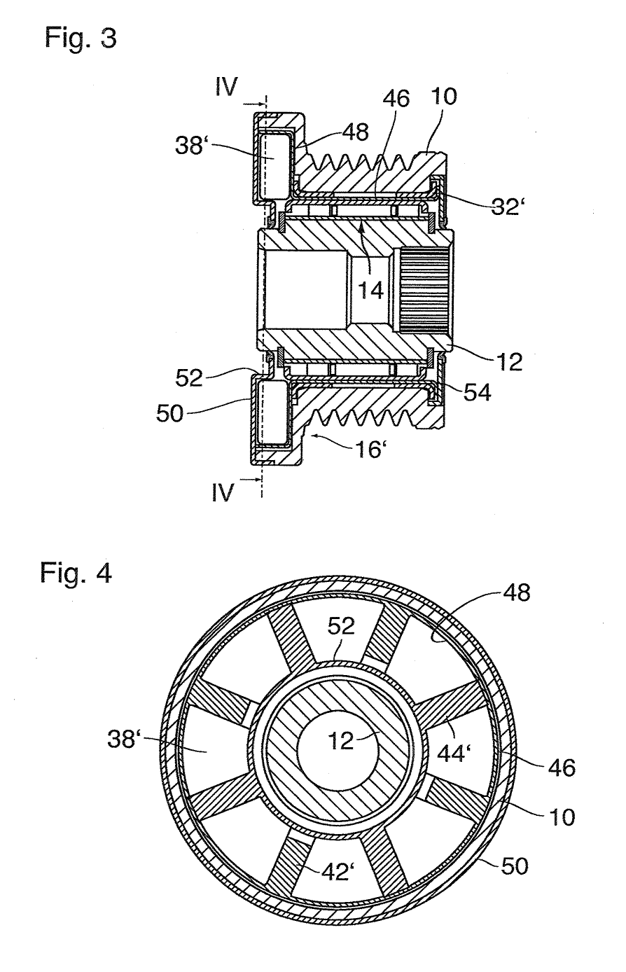

FIG. 3 is an axial section through a device having an alternative arrangement of damping bodies;

FIG. 4 is a sectional view taken in the plane IV-IV in FIG. 3;

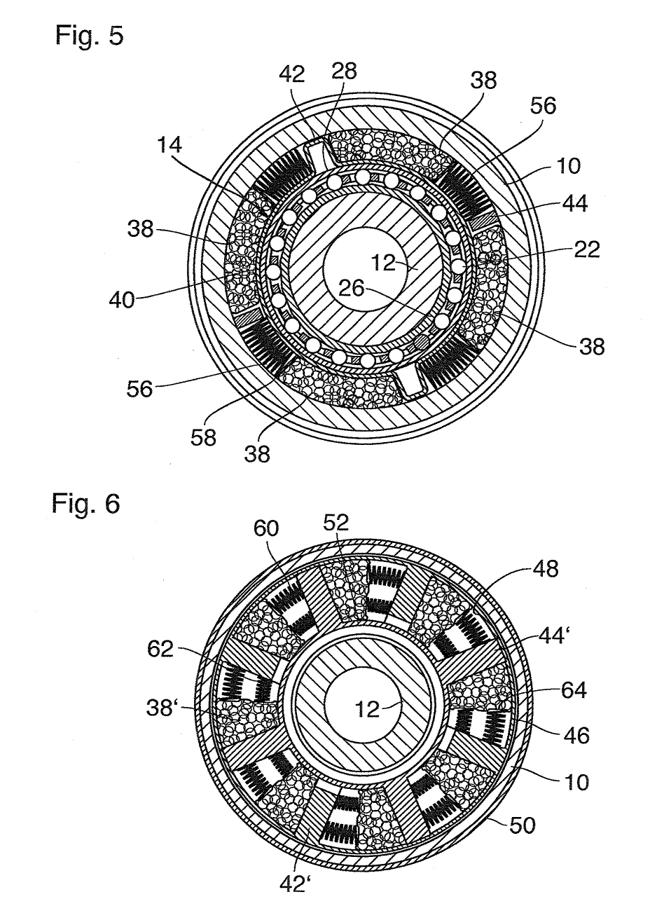

FIG. 5 is a sectional view analogous to FIG. 2, for another embodiment; and

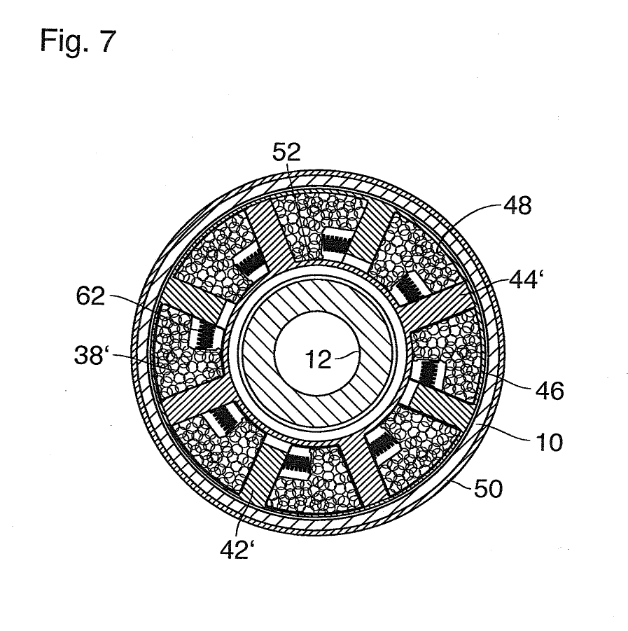

FIGS. 6 and 7 are sectional views analogous to FIG. 4 for further embodiments of the invention.

The device shown in FIG. 1 serves for transmitting a torque from an outer torque transmission ring 10 onto an inner sleeve 12 and comprises a sprag clutch 14 and a damping element 16 which are disposed radially between the torque transmission ring 10 and the sleeve 12. In the example shown, the torque transmission ring 10 is a V-belt pulley driven by a V-ribbed belt which has not been shown. The sleeve 12 has an internal serration 18 with which it may be mounted on a non-shown shaft of an auxiliary aggregate such as a dynamo, for example, by means of a separate tool.

The sprag clutch 14 is flanked on both sides by roller bearings having roller bodies 20 in the form of cylinders and comprises clamping rollers 22 held in a cage 24. An inner race 26 of the sprag clutch forms a common raceway for the clamping rollers 22 and the bearing rollers 20 and has a clamping contour in the region of the clamping rollers 22, as can be seen in FIG. 2. Similarly, an outer race 28 of the sprag clutch forms a common raceway for the clamping rollers 22 and the bearing rollers 20 and is curved inwardly at both axial ends so that it straddles the bearing rollers 20.

The inner race 26 is mounted in a torsionally stiff manner on the sleeve 12 and is fixed at both ends by securing rings 30. Each of the securing rings 30 is straddled by a slide bearing sleeve 32 which is L-shaped in axial section and is surrounded by a pot-shaped sheet metal structure 34 which, in axial section, has a shape of a (horizontal) U. The inner leg of the sheet metal structure 34 is bent inwardly and carries a seal 36 sealing against the periphery of the sleeve 12. The outer legs of two sheet metal structures 34 support the torque transmission ring 10 at both ends. Thus, the torque transmission ring 10 is supported in radial direction by the sheet metal structures 34 and the slide bearing sleeves 32 on the outer race 28 of the sprag clutch and the roller bearings and is at the same time immobilized in axial direction, whereas it may rotate freely in circumferential direction, limited only by the elastic deflection of the damping element 16.

As can be seen more clearly in FIG. 2, the damping element 16 is formed by four separate damping bodies 38 each of which is approximately shaped as a quarter of a circle and which fill the space between the torque transmission ring 10 and the sprag clutch 14 in radial direction. The outer envelope of the sprag clutch is formed by a tappet ring 40 which forms two radially opposite extensions or ribs 42 each of which separates two adjacent damping bodies 38 from one another.

Two ribs 44 are mounted at the inner periphery of the torque transmission ring 10 so as to project radially inwardly, and these rips also separate two adjacent damping bodies 38 from one another. Thus, the damping bodies 38 are held between the ribs 42 of the sprag clutch 14 and the ribs 44 of the torque transmission ring 10 with form-fit in circumferential direction and also fill completely the space between these ribs in circumferential direction.

The damping bodies 38 are made of a wire meshwork which has been pressed into the desired, approximately quarter-cylindrical shape after knitting.

When the torque transmission ring 10 is driven at constant velocity by the V-ribbed belt and this torque transmission ring and the shaft of the dynamo—and hence the sleeve 12—run with exactly the same rotational speed, the torque will be transmitted from the ribs 44 via the damping bodies 38 to the ribs 42 and then to the sprag clutch 14 the clamping rollers 22 of which are in the clamped position, so that the torque will be transmitted further onto the sleeve 12. In the case of speed fluctuations, the sprag clutch will become effective in those phases in which the angular velocity of the torque transmission ring 10 is smaller than that of the sleeve 12, so that the sleeve 12 will not be braked. In the phases in which the angular velocity of the torque transmission ring is larger than that of the sleeve 12, the damping bodies 12 are compressed elastically in circumferential direction, so that the torque shocks can be attenuated.

In the example shown, the resistance of the damping bodies 38 against deformation is further enhanced by the fact that the damping bodies are supported at their inner periphery on the tappet ring 40 and at their outer periphery at the torque transmission ring 10, so that the compression in circumferential direction cannot be compensated by a corresponding increase in the thickness in radial direction.

Since the meshes of the wire meshwork form numerous friction points with one another, the energy of the torsional oscillations will not be absorbed as pure spring energy, as would be the case for example for helical compression springs, but a certain part of the energy will be consumed and converted into heat efficiently by the internal friction of the damping body 38. In particular, the excitation of torsional resonance oscillations will be prevented in this way. Thus, the sprag clutch 14 and all components further downstream in the drive train for the dynamo and other auxiliary aggregates will be effectively protected against increased wear.

FIGS. 3 and 4 show a modified embodiment with a damping element 16′ formed by damping bodies 38′. In comparison to FIGS. 1 and 2, the damping bodies 38′ (simply depicted as white areas here) are offset axially outwardly (to the left side in FIG. 3) into a region beyond the pulley profile and are held between ribs 42′, 44′ of the torque transmission ring and the sprag clutch. The sprag clutch 14 has a sleeve 46 which is firmly held on the outer race and forms, at one axial end, an enlarged receiving space 48 for the damping bodies 38, which receiving space is divided radially by the ribs 42′. The torque transmission ring has a cover 50 with a depression 52 which closes the receiving space 48 at the outer axial end and at the inner periphery and forms the ribs 44. At the opposite end, the torque transmission ring is closed by an annular flange 54, and in the region of the sprag clutch 14, it is supported on the sleeve 46 via slide rings 32′.

FIG. 5 illustrates a modification of the embodiment according to FIGS. 1 and 2, wherein elastic damping elements 56 in the form of helical springs are respectively inserted between one of the ribs 44, 42 and the damping body 38. At least at the ends of each damping element 46 which faces the meshwork of the damping body 38, a disk 58 has been inserted which assures a more even distribution of the force of the helical spring onto the meshwork.

FIG. 6 illustrates a modification of the embodiment example according to FIGS. 3 and 4, wherein two elastic damping elements 60 and 62 have been inserted respectively between the damping body 38′ and one of the ribs 42, 44. Both damping elements are formed by helical springs and are disposed in different radial positions. On the side facing the damping elements 60, 62, the damping bodies 38′ are respectively shaped here in such a manner that they form spring seats 64 for the ends of the helical springs.

FIG. 7 illustrates a further modification of this embodiment example wherein only a single damping element 62 is associated with each of the damping bodies 38′, the damping element being supported between a part of the damping body 38′ and one of the ribs 42′, 44′. Another part (in the radially outer region in this example) of the damping body 38′ formed by the meshwork is supported directly on the ribs 42′ and 44′ and thus constitutes a parallel second force transmission path which bypasses the elastic damping element 62.

In another embodiment, which has not been shown, the damping element 38′ formed by the meshwork could also be configured such that it does not constitute a spring seat for the elastic damping element 62, but instead the damping element 62 is also supported directly between the ribs 42′ and 44′.

What is claimed is:

1. A device for transmission of a torque with torsional vibration damping, comprising:
a torque transmission ring,
a sprag clutch and
a damping element which is arranged coaxially to said sprag clutch and is in driving engagement therewith, the damping element having at least one damping body in the form of a three-dimensional wire meshwork, which is arranged between the torque transmission ring and the sprag clutch and is supported on the torque transmission ring and the sprag clutch in a circumferential direction.

2. The device according to claim 1,
further comprising ribs projecting radially from the torque transmission ring on the one hand and from the sprag clutch on the other hand, and
wherein the damping element is held between the ribs with a form-fit in the circumferential direction.

3. The device according to claim 2, wherein each damping body is arranged to completely fill an associated space between the sprag clutch, the torque transmission ring and the ribs.

4. The device according to claim 1, wherein the damping element surrounds the sprag clutch at an outer periphery thereof.

5. The device according to claim 4, wherein the torque transmission ring is includes a pulley which surrounds the damping element at an outer periphery thereof.

6. The device according to claim 4, wherein the torque transmission ring is supported on the sprag clutch without play in a radial direction.

7. The device according to claim 6, wherein the torque transmission ring is rigidly supported by pot-shaped sheet metal rings and slide bearing sleeves disposed at opposite ends of the damping element.

8. The device according to claim 1, further comprising at least one roller bearing having rollers supported between an inner race and an outer race of the sprag clutch.

9. The device according to claim 1, wherein the damping element is formed by a plurality of separate damping bodies each of which has a cross-sectional shape in the form of a ring segment.

10. The device according to claim 1, wherein the damping element has, in addition to the at least one damping body formed by the meshwork, at least one elastic damping element in the form of one of:
a helical spring,
a dish spring,
a leaf spring, and
a rubber block.

11. The device according to claim 10, wherein the at least one elastic damping element is arranged in series with the at least one damping body in a flow of force between the torque transmission ring and the sprag clutch.

12. The device according to claim 10, wherein the at least one damping body and the at least one elastic damping element form parallel force transmission paths.
